(19) United States
(12) Patent Application Publication
(10) Pub. No.: US 2019/0168701 A1
(43) Pub. Date: Jun. 6, 2019

(54) PEDESTRIAN PROTECTION DEVICES AND RELATED METHODS

(71) Applicant: SABIC Global Technologies B.V., Bergen op Zoom (NL)

(72) Inventors: Warden Schijve, Geleen (NL); Gertrudis Winters, Geleen (NL); Sandeep Kulkarni, Geleen (NL)

(21) Appl. No.: 16/323,463

(22) PCT Filed: Aug. 4, 2017
(86) PCT No.: PCT/IB2017/054802

§ 371 Date: Feb. 5, 2019

Related U.S. Application Data
(60) Provisional application No. 62/371,446, filed on Aug. 5, 2016.

(51) Int. Cl. B60R 19/18; B60R 21/34

(52) U.S. Cl. CPC B60R 19/18; B60R 21/34; B60R 2019/186; B60R 2021/343; B60R 2019/1853

(57) ABSTRACT

Pedestrian protection device including a composite body (146) having a plastic material (150) and one or more laminates (154), each including fibers (158) dispersed within a matrix material, wherein the body (146) defines an elongated beam (74) extending between first and second ends, the elongated beam (74) having first and second flanges (86), each extending between the first and second ends, and a web (94) extending between and connecting the first and second flanges (86), and wherein at least one of the one or more laminates (154) is disposed along the first flange (86, 90) and/or at least one of the one or more laminates (154) is disposed along the second flange (86, 90). In some devices, an outer surface (126, 130) of the first flange (86, 90) that faces away from the along the second flange (86, 90) is convex. In some devices, the matrix material of at least one of the one or more laminates (154) includes the plastic material (150).

### CROSS-REFERENCE TO RELATED APPLICATIONS

This application claims the benefit of priority of U.S. Provisional Patent Application No. 62/371,446 filed Aug. 5, 2016, which is hereby incorporated by reference in its entirety.

### BACKGROUND

### 1. Field of Invention

The present invention relates generally to pedestrian protection, and more specifically, but not by way of limitation, to devices configured to guide pedestrian leg movement during impact with a vehicle to reduce the risk of certain injuries to the pedestrian and related methods.

### 2. Description of Related Art

Due to increased interest in pedestrian protection, standards have been created requiring vehicle manufactures to provide bumper systems that, during impact with a pedestrian, reduce forces exerted on the pedestrian, mitigate pedestrian leg injuries, and/or the like.

Some such bumper systems include an energy absorber (e.g., a foam, thermoplastic, and/or the like energy absorber) and a leg protection device that is disposed below the energy absorber. During impact with a pedestrian, the energy absorber can reduce forces exerted on the pedestrian, and the leg protection device can guide pedestrian leg movement to, for example, resist intrusion of the lower part of the leg farther than the knee, thereby reducing bending and shear loads on the knee, reducing the risk of entrapment of the pedestrian beneath the vehicle, and/or the like.

Some leg protection devices are made of metal, whether of tubular and/or stamped construction. Metal leg protection devices may, via their metal construction, be undesirably heavy, be limited in possible shapes and geometries (e.g., imposing vehicle design limitations), be prone to non-uniform stiffness across their lengths, and/or the like.

Some leg protection devices are made of a thermoplastic material. A typical thermoplastic leg protection device, sometimes referred to as an undertray or splash shield, can include a plate-like structure that is corrugated to increase stiffness in the impact direction. Such thermoplastic leg protection devices can be relatively large, which may impose vehicle design limitations, complicate mounting of the leg protection devices, complicate vehicle maintenance, and/or the like.

Examples of leg protection devices are disclosed in U.S. Pat. No. 8,684,427.

### SUMMARY

Some embodiments of the present pedestrian protection devices are configured to have: (1) sufficient bending and/or torsional stiffness to mitigate pedestrian leg injuries during impact with the pedestrian (e.g., a bending and/or torsional stiffness that is substantially equal to or greater than a corresponding bending and/or torsional stiffness of a comparable metal leg protection device); and/or (2) a reduced weight and/or size (e.g., when compared to the comparable metal leg protection device or a comparable thermoplastic leg protection device), via, for example: (i) a composite construction including a plastic material and one or more laminates, each comprising fibers dispersed within a matrix material; (ii) an elongated beam including first and second flanges and a web extending between and connecting the first and second flanges (e.g., an I-shaped cross-section); and/or (iii) one or more laminates disposed along the first flange and/or one or more laminates disposed along the second flange ((ii) and (iii) may each increase an amount and/or stiffness of beam material that is spaced apart from the neutral axis of the beam).

Some embodiments of the present pedestrian protection devices are configured to have more uniform bending and/or torsional stiffness along a length of the device (e.g., when compared to a comparable metal leg protection device), via, for example: (i) an elongated beam extending between first and second ends and including first and second flanges, each extending between the first and second ends, and a web extending between and connecting the first and second flanges, wherein the width, height, and/or thickness of the first flange, second flange, and/or web decreases toward at least one of (e.g., each of) the first and second ends; and/or (ii) one or more laminates disposed along the first flange and/or one or more laminates disposed along the second flange, wherein the width, height, and/or thickness of the one or more laminates disposed along the first flange and/or the one or more laminates disposed along the second flange decreases toward at least one of the first and second ends.

Some embodiments are configured to facilitate a bond between a plastic material of a composite body and one or more laminates of the composite body, each of the one or more laminates comprising fibers dispersed within a matrix material, via, for example, the matrix material of the one or more laminates comprising (e.g., consisting of) the plastic material.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially” and “approximately” may be substituted with “within [a percentage] of” what is specified, where the percentage includes 0.1, 1, 5, and 10 percent.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

As used in this disclosure, a “lamina” is a layer of material that is formed by introducing a matrix material into an arrangement of fibers, and “laminae” is the plural form of lamina. A “laminate” is a layer of material including one or more laminae, whether or not consolidated.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, a device that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those steps.

Any embodiment of any of the devices, systems, and methods can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments are described above, and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the embodiment depicted in the figures.

FIG. 1 is a schematic cross-sectional side view of a bumper system of a vehicle.

FIG. 2A is a front perspective view of a first embodiment of the present pedestrian protection devices.

FIG. 2B is a schematic cross-sectional end view of the device of FIG. 2A, taken along line 2B-2B of FIG. 2A.

FIG. 2C is an enlarged rear perspective view of the device of FIG. 2A.

FIG. 3 is a front perspective view of the device of FIG. 2A, shown coupled to a portion of a bumper cover.

FIGS. 4A and 4B are schematic top views of embodiments of the present pedestrian protection devices, showing various rib configurations.

FIGS. 5A-5C are schematic exploded views of laminates that may be suitable for use in some embodiments of the present pedestrian protection devices.

FIG. 6 is a front perspective view of the device of FIG. 2A.

FIG. 7 is a schematic view of a laminate having a varying thickness that may be suitable for use in some embodiments of the present pedestrian protection devices.

FIG. 8 depicts a simulated lower leg impact on the device of FIG. 2A.

FIG. 9 is a graph depicting the stiffness of the device of FIG. 2A and the stiffness of a comparable steel leg protection device in response to the simulated lower leg impact of FIG. 7.

### DETAILED DESCRIPTION

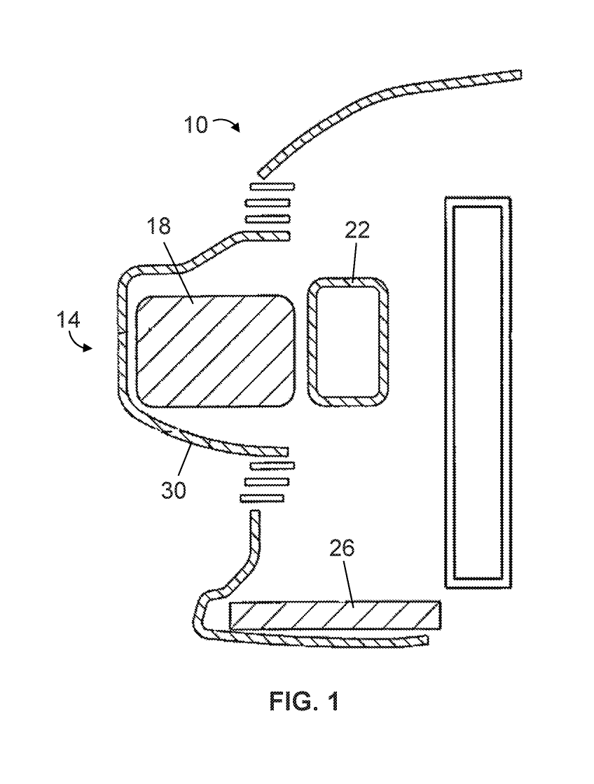

FIG. 1 depicts a vehicle 10 including a bumper system 14. Bumper system 14 can include an energy absorber 18, which, as shown, can be coupled to a bumper beam 22. For example, energy absorber 18 can comprise a material and/or structure that is capable of absorbing energy via crushing, such as a foam (e.g., a polystyrene, polyurethane, polyether, polyethylene, polypropylene, and/or the like foam), a crushable structure, and/or the like. In at least this way, energy absorber 18 can be configured to reduce the magnitude of force exerted on a pedestrian during impact of the pedestrian with bumper system 14. Bumper system 14 can include a leg protection device 26, which can be disposed below energy absorber 18, configured to guide pedestrian leg movement during impact of the pedestrian with the bumper system to, for example, resist intrusion of the lower part of the leg farther than the knee. For example, leg protection device 26 can be stiffer than energy absorber 18. In at least this way, leg protection device 26 can reduce bending and/or shear loads on the knee, which might otherwise result in tibia fractures, intraarticular bone fractures, ligament ruptures, and/or the like, reduce the risk of pedestrian entrapment beneath vehicle 10, and/or the like. At least a portion of bumper system 14 can be disposed beneath a fascia or bumper cover 30.

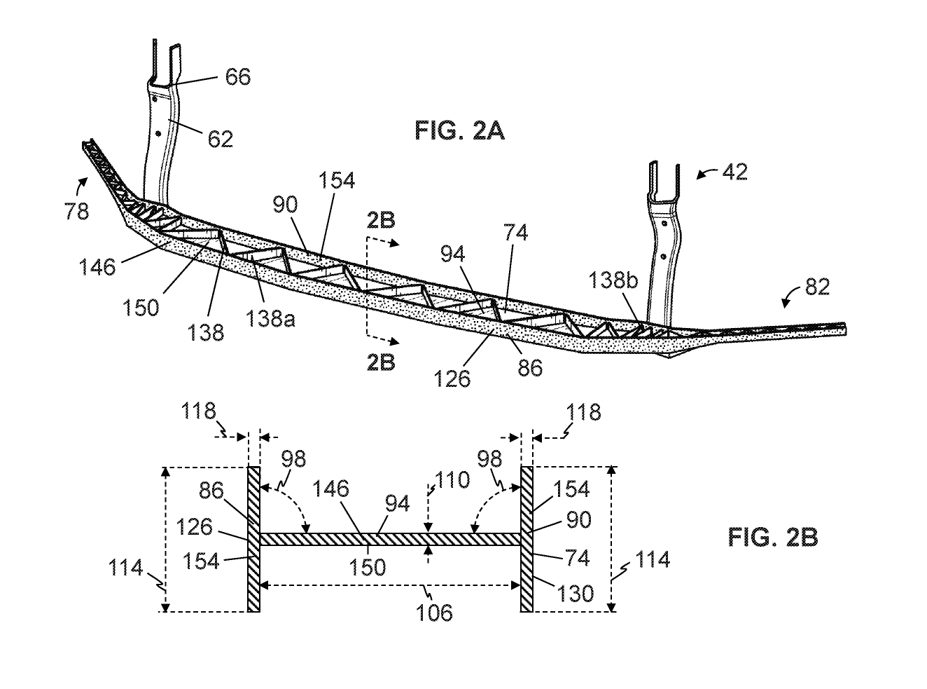

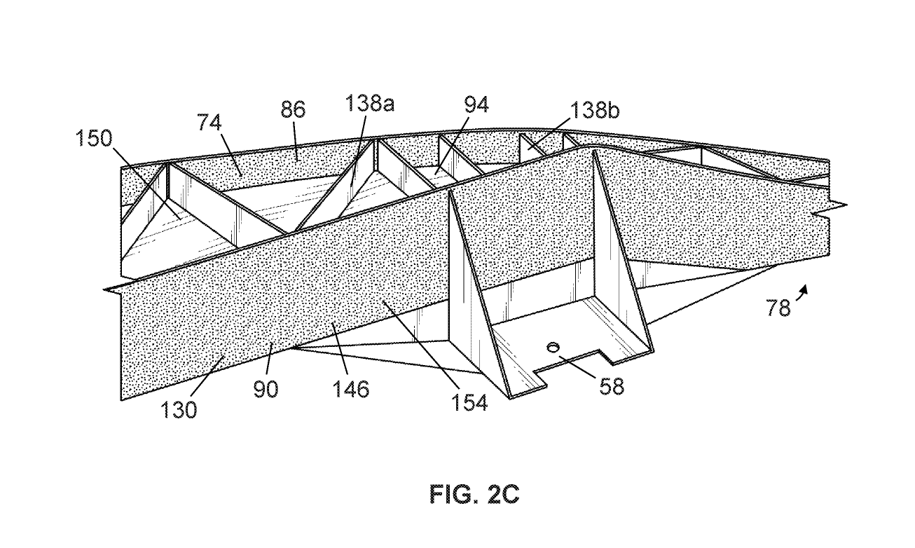

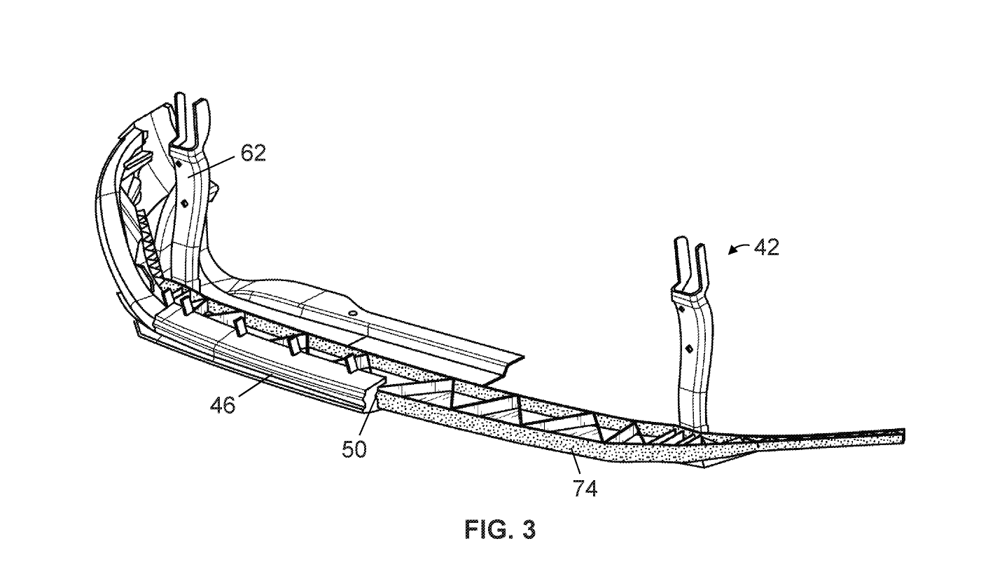

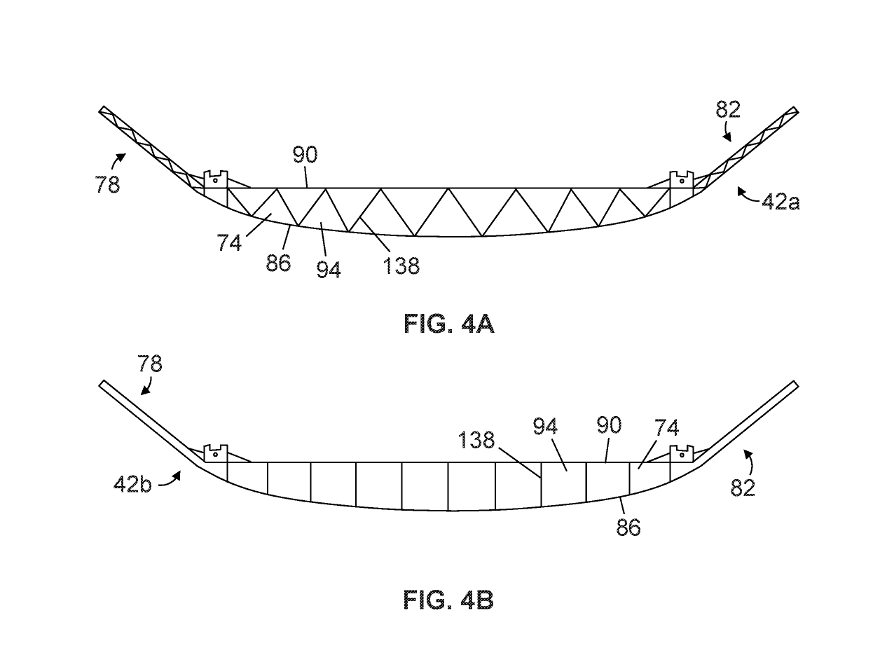

Referring now to FIGS. 2A-3, shown is one embodiment 42 of the present pedestrian protection devices. Device 42 can be a component of a bumper system (e.g., 14), such as a leg protection device (e.g., 26) of the bumper system. For example, device 42 can be mounted to the front of a vehicle (e.g., a car, truck, bus, or the like) such that the device is coupled to, forms at least a portion of, or is disposed proximate to a chin spoiler, air dam, front valence, and/or the like of the vehicle. As shown in FIG. 3, at least a portion of device 42 can be disposed within a fascia or bumper cover 46. For example, fascia or bumper cover 46 can define a recess 50 within which at least a portion of device 42, such as beam 74 (described below), can be received.

Device 42 can include one or more mounts 58 for coupling the device to the vehicle (FIG. 2C). Mount(s) 58 can each be coupled to beam 74 (e.g., at second flange 90). More particularly, device 42 can include one or more brackets 62, each configured to be coupled between a respective one of mount(s) 58 and the vehicle. Each of bracket(s) 62 can define a channel 66 to, for example, increase the stiffness of the bracket. Bracket(s) 62 may comprise a metal (e.g., steel, aluminum, titanium, and/or the like), a plastic material (e.g., a thermoplastic, thermoset, and/or the like material, whether or not fiber-filled, which may be reinforced by one or more laminates), and/or the like. In order to increase the effectiveness of device 42 (e.g., for guiding pedestrian leg movement during impact with the pedestrian), the device (e.g., via mount(s) 58 and/or bracket(s) 62) can be coupled to a relatively stiff portion of the vehicle, such as, for example, a bumper beam, frame, unibody, and/or the like.

Device 42 can include an elongated beam 74 extending between a first end 78 and a second end 82. Beam 74 can include a first flange 86 and a second flange 90, each extending between, but not necessarily to each of, first end 78 and second end 82. Beam 74 can include a web 94 extending between and connecting first flange 86 and second flange 90. At least a portion of one of (e.g., each of) first flange 86 and second flange 90 can extend above and below web 94. At least a portion of web 94 that extends between first and second flanges, 86 and 90, respectively, can be substantially planar or plate-like.

As shown in FIG. 2B, at least a portion of each of first flange 86 and second flange 90 can be angularly disposed relative to at least a portion of web 94 at an angle 98, such as, for example, an angle that is greater than any one of, or between any two of: 25, 30, 35, 40, 45, 50, 55, 60, 65, 70, 75, 80, 85, 90, 95, 100, 105, 110, 115, 120, 125, 130, 135, 140, 145, 150, or 155 degrees. Angle 98 for first flange 86 can be different than angle 98 for second flange 90. In device 42, for at least one of (e.g., each of) first flange 86 and second flange 90, angle 98 can be substantially 90 degrees. For example, when device 42 is coupled to the vehicle, first and/or second flanges, 86 and 90, respectively, can be substantially vertical and web 94 can be substantially horizontal. For further example, at least a portion of beam 74 can comprise an I-shaped cross-section. In other embodiments, by varying the structure and/or relative locations and/or orientations of flange(s) (e.g., 86 and/or 90) and/or a web (e.g., 94), at least a portion of a beam (e.g., 74) can have any suitable cross-section, such as, for example, a U-shaped cross-section, a Z-shaped cross-section, a W-shaped cross-section (e.g., via the web including first and second substantially planar portions that are angularly disposed relative to one another), and/or the like.

In these ways and others, substantial portions of beam 74, such as first flange 86 and second flange 90, can be spaced apart from a neutral axis of the beam, thereby increasing the bending and/or torsional stiffness of the beam and thus the ability of device 42 to mitigate pedestrian leg injuries during impact with the pedestrian.

Portions of beam 74 at or proximate to locations where the beam is coupled to the vehicle (e.g., via mount(s) 58 and/or bracket(s) 62) can be less stiff than other portions of the beam, to, for example, take advantage of stiffness provided by the coupling between the beam and the vehicle. To illustrate, a width 106 of web 94, which can be largest at or proximate to the middle of beam 74, can decrease toward at least one of (e.g., each of) first end 78 and second end 82. In some embodiments, a thickness (e.g., 110) of a web (e.g., 94) and/or a height (e.g., 114) and/or thickness (e.g., 118) of a first flange (e.g., 86) and/or second flange (e.g., 90), each of which can be largest at or proximate to the middle of a beam (e.g., 74), can decrease toward at least one of (e.g., each of) a first end (e.g., 78) and second end (e.g., 82) of the beam. In these ways and others, a weight of beam 74 can be reduced, and/or, when coupled to the vehicle, device 42 can facilitate a uniform stiffness along beam 74 (e.g., allowing the device to respond similarly to pedestrian impacts at various locations along the beam).

In the embodiment shown, no portion of beam 74 (e.g., first flange 86, second flange 90, and web 94) extends beyond an outer surface 126 of the first flange that faces away from the second flange. In this embodiment, no portion of beam 74 (e.g., first flange 86, second flange 90, and web 94) extends beyond an outer surface 130 of the second flange that faces away from the first flange. Through such feature(s), placement of beam 74 relative to the vehicle (e.g., within fascia or bumper cover 46) can be facilitated, a weight of beam 74 can be reduced, and/or the like. Nevertheless, in other embodiments, portion(s) of a beam (e.g., 74) can extend beyond an outer surface (e.g., 126) of a first flange (e.g., 86) and/or an outer surface (e.g., 130) of a second flange (e.g., 90).

At least a portion of beam 74 can be curved. For example, outer surface 126 of first flange 86 can be convex. In other embodiments, an outer surface (e.g., 126) of a first flange (e.g., 86) can be concave. In some embodiments, an outer surface (e.g., 130) of a second flange (e.g., 90) can be concave or convex. Such curvature can, for example, facilitate variations in the distance between first flange 86 and second flange 90 along beam 74, placement of the beam relative to the vehicle (e.g., within fascia or bumper cover 46), and/or the like.

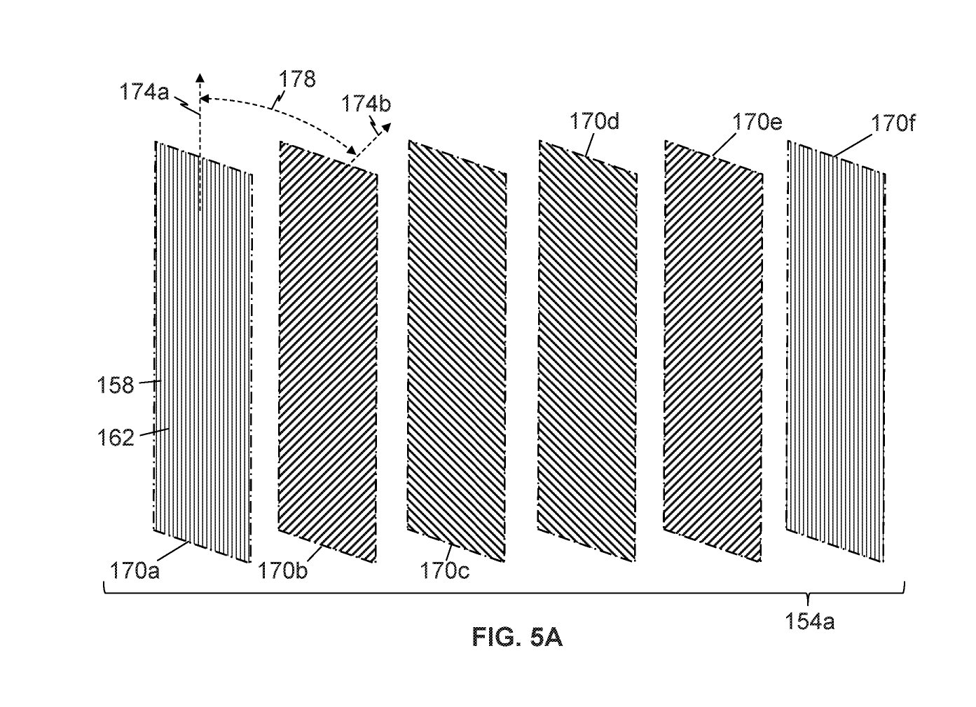

Device 42 can include one or more ribs 138 extending from web 94 and between first flange 86 and second flange 90. Referring additionally to FIGS. 4A and 4B, ribs (e.g., 138) of a device can be angularly disposed (e.g., at an angle that is between approximately 30 degrees and approximately 60 degrees) relative to a long dimension of a respective beam (e.g., 74) (e.g., ribs 138a of device 42, ribs 138 of device 42a, and/or the like) and/or substantially perpendicular to the long dimension of the respective beam (e.g., ribs 138b of device 42, ribs 138 of device 42b, and/or the like). Such ribs (e.g., 138) can increase the stiffness of a beam (e.g., 74) in exchange for a relatively small increase in the weight of the beam.

Device 42 can comprise a composite body 146 that defines beam 74, mount(s) 58, ribs 138, and/or the like. Body 146 can be characterized as a “composite” in that the body comprises a plastic material 150 and one or more laminates 154, where the plastic material and the laminate(s) are combined to form a unitary structure. As one non-limiting example, body 146 can be formed by overmolding plastic material 150 onto one or more laminates 154.

Plastic material 150 can comprise a thermoplastic material, such as polyethyleneimine, polyetherimide, or a derivative thereof, polyethylene terephthalate, polycarbonate, polybutylene terephthalate, poly(1,4-cyclohexylidene cyclohexane-1,4-dicarboxylate), glycol-modified polycyclohexyl terephthalate, poly(phenylene oxide), polypropylene, polyethylene, polyvinyl chloride, polystyrene, polymethyl methacrylate, thermoplastic elastomer, terephthalic acid elastomer, poly(cyclohexanedimethylene terephthalate), polyethylene naphthalate, polyamide (e.g., PA6, PA66, and/or the like), polysulfone sulfonate, polyether ether ketone, polyether ketone ketone, acrylonitrile butyldiene styrene, polyphenylene sulfide, polycarbonate/polybutylene succinate, a co-polymer thereof, or a combination thereof, or a thermoset material, such as unsaturated polyester resin, polyurethane, bakelite, duroplast, urea-formaldehyde, diallyl-phthalate, epoxy resin, epoxy vinylester, polyimide, cyanate ester of polycyanurate, dicyclopentadiene, benzoxazine, a co-polymer thereof, or a combination thereof. Plastic material 150 can include dispersed elements, such as, for example, discontinuous or short fibers (e.g., carbon fibers, glass fibers, basalt fibers, aramid fibers, polyethylene fibers, polyester fibers, polyamide fibers, steel fibers, textile fibers, or a combination thereof), which can account for 10 to 70% of the plastic material by weight.

One or more laminates (e.g., 154) can each include any suitable number of laminae (e.g., 1, 2, 3, 4, 5, 6, 7, 8, 9, 10, or more laminae), each having fibers (e.g., 158) dispersed within a matrix material (e.g., 162). For example, a lamina can comprise from 30 to 70% fibers (e.g., 158) by volume and/or from 10 to 85% fibers by weight. A matrix material (e.g., 162) of a lamina can include any suitable matrix material, such as, for example, one or more of the thermoplastic materials described above and/or one or more of the thermoset materials described above. A matrix material (e.g., 162) of a lamina can comprise (e.g., consist of) a plastic material (e.g., 150) of a composite body (e.g., 146), facilitating a bond between the plastic material and the lamina within the composite body.

Fibers (e.g., 158) of a lamina can include any suitable fibers, such as, for example, any of the fibers described above. Fibers (e.g., 158) of a lamina can be arranged and/or structured in any suitable fashion. For example, fibers (e.g., 158) of a lamina can be continuous and/or discontinuous. For further example, fibers (e.g., 158) of a lamina can include yarns, which, in turn, can comprise braided and/or commingled strands, and such a yarn can include strands of a first material (e.g., a polymeric material) and strands of a second material (e.g., a non-polymeric material) that is different than the first material. For yet further example, fibers (e.g., 158) of a lamina can be oriented relative to one another such that substantially all of the fibers are substantially parallel to one another (e.g., as in a lamina formed from a unidirectional fiber tape), such that the fibers define a woven structure (e.g., as in a lamina having a plane, twill, satin, basket, leno, mock leno, or the like weave, whether two- or three-dimensional), or the like.

As will be described in more detail below, laminate(s) (e.g., 154) can be disposed along a structure, such as beam 74, to increase the bending and/or torsional stiffness of the structure. To illustrate, for a given laminate (e.g., 154) disposed along beam 74, fibers (e.g., 158) that are substantially aligned with the beam direction (e.g., a direction along the beam between first end 78 and second end 82) can increase the bending stiffness of the beam, and fibers that are angularly disposed relative to the beam direction can increase the torsional stiffness of the beam.

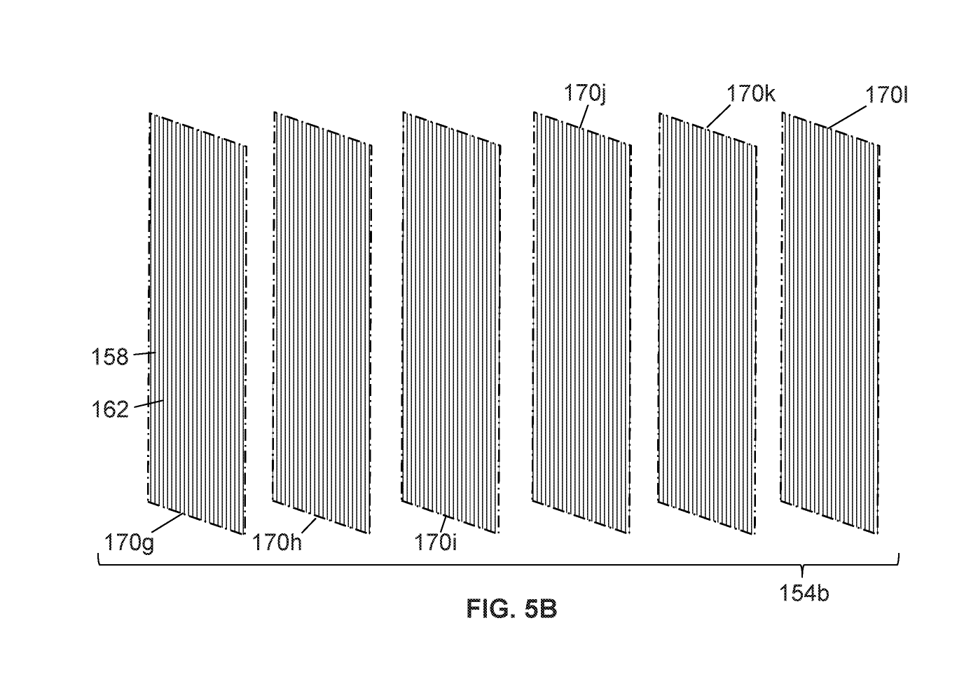

FIG. 5A depicts a schematic exploded view of a laminate 154a that may be suitable for use in some devices (e.g., 42). Laminate 154a can include a lamina 170a in which substantially all of fibers 158 are substantially parallel to one another (e.g., the lamina can be formed from a unidirectional fiber tape). Fibers 158 of lamina 170a can be aligned in a first direction 174a, and laminate 154a can include a lamina 170b having fibers 158 aligned in a second direction 174b that is angularly disposed relative to the first direction. For example, a smallest angle 178 between first direction 174a and second direction 174b can be approximately 5, 10, 15, 20, 25, 30, 35, 40, 45, 50, 55, 60, 65, 70, 75, 80, 85, or 90 degrees. More particularly, laminate 154a can include six (6) laminae, 170a-170f, each having fibers 158 that are angularly disposed at approximately 0, 45, −45, −45, 45, and 0 degrees, respectively, relative to a long dimension of the lamina and/or the laminate and/or to a structure along which the laminate is disposed (e.g., if the laminate is disposed along beam 74, relative to the beam direction). Other laminate(s) (e.g., 154) can each include lamina(e) having fibers that are angularly disposed at any suitable angle relative to a long dimension of the lamina and/or the laminate and/or to a structure along which the laminate is disposed, such as, for example, approximately −90, −85, −80, −75, −70, −65, −60, −55, −50, −45, −40, −35, −30, −25, −20, −15, −10, −5, 0, 5, 10, 15, 20, 25, 30, 35, 40, 45, 50, 55, 60, 65, 70, 75, 80, 85, and/or 90 degrees. Laminae of a laminate (e.g., 154) can be stacked in a symmetric (e.g., FIG. 5A) or asymmetric configuration.

FIG. 5B depicts a schematic exploded view of a laminate 154b that may be suitable for use in some devices (e.g., 42). As shown, laminate 154b can include one or more laminae (e.g., 1, 2, 3, 4, 5, 6, 7, 8, 9, 10, or more lamina(e)) (e.g., 170g-170l), each having fibers 158, substantially all of which are substantially parallel to one another (e.g., each of the lamina(e) can be formed from a unidirectional fiber tape). In laminate 154b, each lamina (e.g., 170g-170l) can include fibers 158 that are substantially aligned with a long dimension of the lamina and/or the laminate and/or to a structure along which the laminate is disposed.

FIG. 5C depicts a schematic exploded view of a laminate 154c that may be suitable for use in some devices (e.g., 42). Laminate 154c can include a lamina 170m having fibers 158 that define a woven structure. For example, lamina 170m can include a first set of fibers 158 that are substantially aligned with one another and a second set of fibers 158 that are substantially aligned with one another, where the second set of fibers is woven with and angularly disposed relative to the first set of fibers. More particularly, lamina 170m of laminate 154c can be a 0/90 lamina in which the second set of fibers is angularly disposed relative to the first set of fibers at an angle of approximately 90 degrees, and one of the first set of fibers and the second set of fibers is substantially aligned with a long dimension of the lamina and/or the laminate and/or a structure along which the laminate is disposed. Laminate 154c can include six (6) laminae, 170m-170r, each of which can be a 0/90 lamina; however, other laminate(s) (e.g., 154) can include 0/90, +30/−60, −30/+60, +45/−45, and/or the like woven lamina(e) (e.g., as well as non-woven lamina(e)).

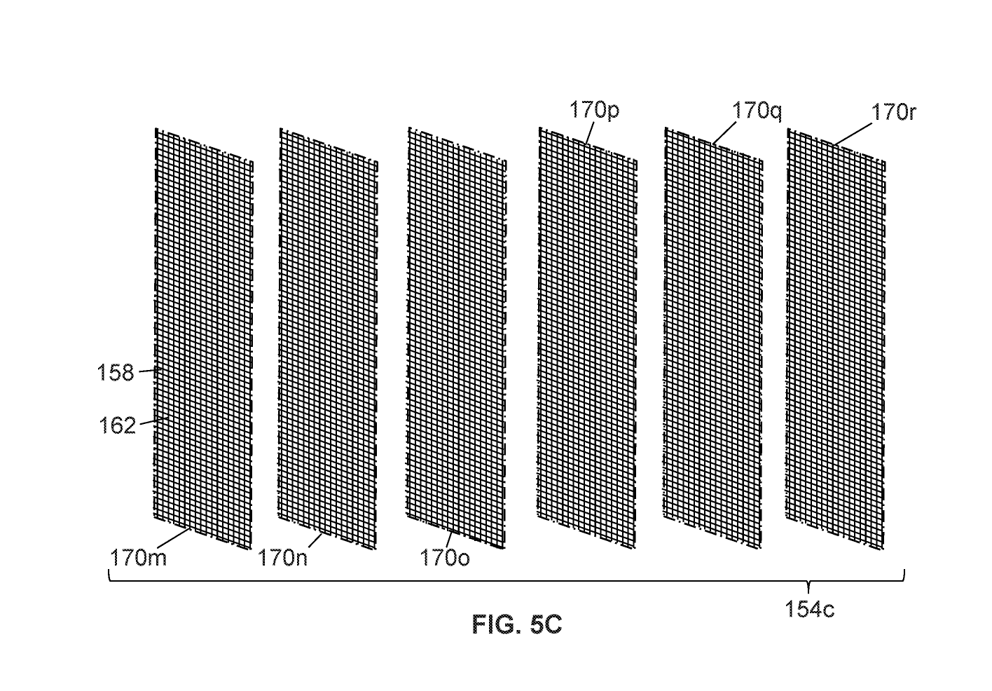

One or more of laminate(s) 154 can be disposed along beam 74, to, for example, increase the bending and/or torsional stiffness of the beam. Laminate(s) 154 that are disposed along beam 74 can have fibers (e.g., 158) that are substantially aligned with the beam direction and/or fibers (e.g., 158) that are angularly disposed relative to the beam direction (e.g., at an angle of approximately 15, 30, 45, 60, 75, and/or 90 degrees). To illustrate, one or more of laminate(s) 154 can be disposed along first flange 86 of beam 74. Laminate(s) 154 that are disposed along first flange 86 can span a total distance along the first flange that is approximately 5, 10, 15, 20, 25, 30, 35, 40, 45, 50, 55, 60, 65, 70, 75, 80, 85, 90, 95, or 100% of a distance 190, measured along the first flange, between first end 78 and second end 82 (FIG. 6). For example, laminate(s) 154 that are disposed along first flange 86 can span a total distance along the first flange that is substantially equal to distance 190. First flange 86 can be comprised substantially of, by weight and/or volume, (e.g., consist of) one or more of laminate(s) 154.

To further illustrate, one or more of laminate(s) 154 can be disposed along second flange 90 of beam 74. Laminate(s) 154 that are disposed along second flange 90 can span a total distance along the second flange that is approximately 5, 10, 15, 20, 25, 30, 35, 40, 45, 50, 55, 60, 65, 70, 75, 80, 85, 90, 95, or 100% of a distance 198, measured along the second flange, between first end 78 and second end 82 (FIG. 6). For example, laminate(s) 154 that are disposed along second flange 90 can span a total distance along the second flange that is substantially equal to distance 198. Second flange 90 can be comprised substantially of, by weight and/or volume, (e.g., consist of) one or more of laminate(s) 154. In these ways and others, one or more of laminate(s) 154 can be disposed along portion(s) of beam 74 that are spaced apart from the neutral axis of the beam, such as first flange 86 and second flange 90, thereby facilitating the laminate(s) in increasing the bending and/or torsional stiffness of the beam. In some devices (e.g., 42), laminate(s) (e.g., 154) may not be disposed along a web (e.g., 94) of a beam (e.g., 74), to, for example, reduce the weight and/or cost of the beam.

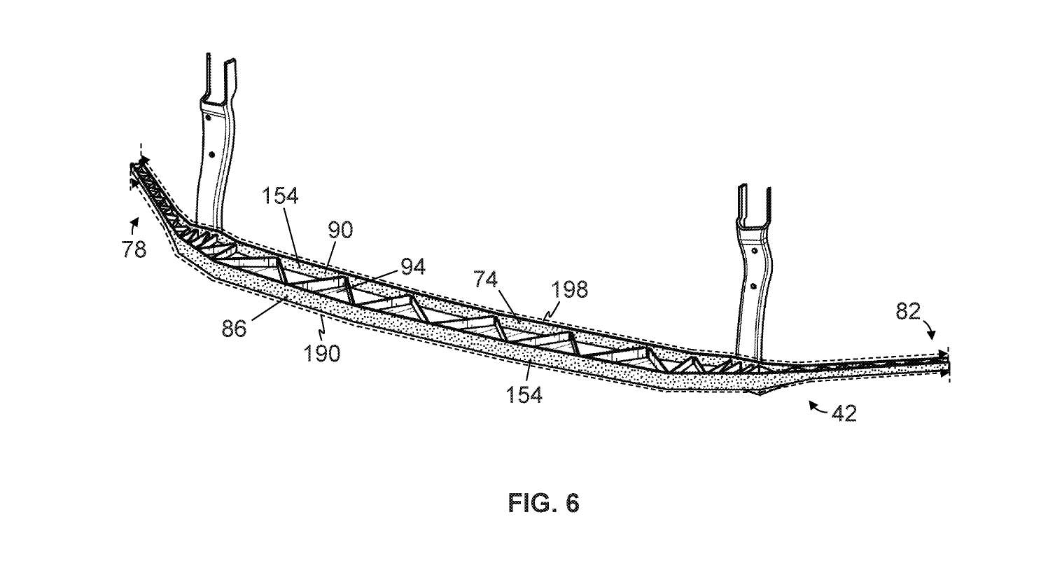

A thickness of laminate(s) 154 that are disposed along first flange 86, which can be largest at or proximate to the middle of beam 74, can decrease along the beam toward at least one of (e.g., each of) first end 78 and second end 82. Similarly, a thickness of laminate(s) 154 that are disposed along second flange 90, which can be largest at or proximate to the middle of beam 74, can decrease along the beam toward at least one of (e.g., each of) first end 78 and second end 82. As shown in FIG. 7, a laminate (e.g., 154c) can have a varying thickness (e.g., 206) via a lay-up of laminae (e.g., 170s-170v) of differing dimensions (e.g., lengths). In at least this way, a weight and/or cost of beam 74 can be reduced, and/or, when coupled to the vehicle, device 42 can facilitate a uniform stiffness along beam 74 (e.g., similarly to as described above).

The present devices, at least via composite body (e.g., 146), may not be subject to manufacturing constraints associated with other leg protection devices, such as tubular and/or stamped metal leg protection devices. To illustrate, the present devices can include a composite body (e.g., 146) having any suitable plastic material (e.g., 150), laminate fibers (e.g., 158), laminate matrix material (e.g., 162), shape, size, placement, and/or the like of laminate(s) (e.g., 154) within the composite body, shape, size, placement, and/or the like of flange(s) (e.g., 86 and/or 90) and/or a web (e.g., 94) of a beam (e.g., 74) defined by the composite body, and/or the like, and such parameters may vary depending on the application.

Some embodiments of the present methods comprise, forming, in a mold, a composite body (e.g., 146) including a plastic material (e.g., 150) and one or more laminates (e.g., 154), each having fibers (e.g., 158) dispersed within a matrix material (e.g., 162). In some methods, forming, in the mold, the body comprises forming the one or more laminates in the mold. For example, in some methods, forming the one or more laminates in the mold comprises placing one or more layers of material, each comprising an arrangement of fibers, into the mold and overmolding the plastic material onto the one or more layers of material (e.g., thereby introducing the plastic material into the arrangement(s) of fibers to form the one or more laminates). Some methods comprise placing the one or more (e.g., at least partially pre-formed) laminates into the mold and overmolding the plastic material onto the one or more laminates. In some methods, the one or more laminates are at least partially consolidated (e.g., heated and/or compressed) before the one or more laminates are placed into the mold.

### EXAMPLES

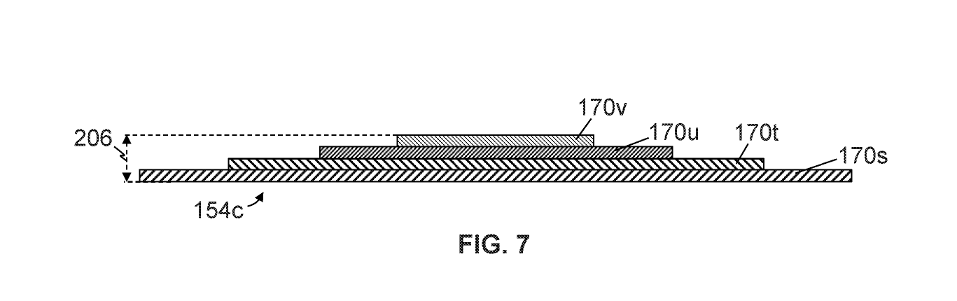

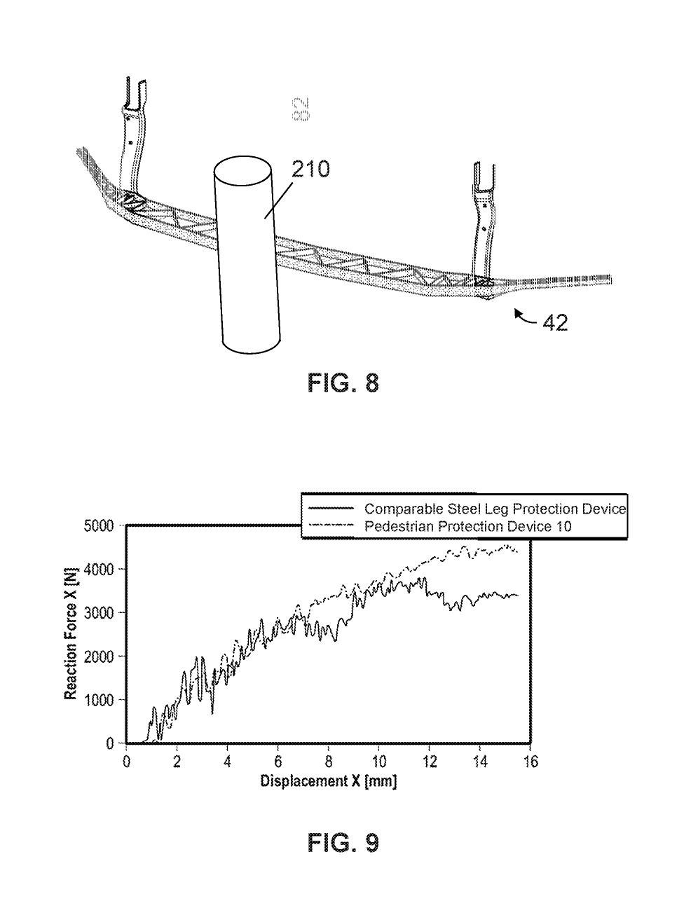

The following example, which is provided for illustrative purposes, is non-limiting. Structural analysis software was used to compare the stiffness of device 42 with that of a comparable steel leg protection device. In this example, device 42 includes a laminate 154 disposed along first flange 86 and a laminate 154 disposed along second flange 90. The laminate disposed along the first flange extends a distance along the first flange that is substantially equal to a distance 190, measured along the first flange, between first end 78 and second end 82. The laminate disposed along the second flange extends a distance along the second flange that is substantially equal to a distance 198, measured along the second flange, between the first end and the second end. The laminate disposed along the first flange has a substantially uniform thickness of approximately 3.0 millimeters (mm), and the laminate disposed along the second flange has a substantially uniform thickness of approximately 1.5 mm. In a simulated pedestrian impact, the forward-facing portion of a model of each device was struck with a model of a lower leg impactor 210 (FIG. 8). Resulting stiffness data for device 42 and the comparable steel leg protection device are shown in FIG. 9.

Despite being 30% lighter than the comparable steel leg protection device, the stiffness of device 42 approximates the stiffness of the steel leg protection device at lower loads and exceeds the stiffness of the steel leg protection device at higher loads. Based on the foregoing, the stiffness of device 42 could be reduced to more closely approximate the stiffness of the comparable steel leg protection device (e.g., resulting in increased weight savings for device 42). While the above simulation was performed using a model of lower leg impactor 210, the present devices can be designed to work with other lower leg impactors, such as, for example, a TRL legform, a Flex-PLI, and/or the like (e.g., by varying one or more of the parameters described above).

Some embodiments of the present pedestrian protection devices configured to be mounted to the front of a vehicle comprise: a composite body including a plastic material and one or more laminates, each comprising fibers dispersed within a matrix material, wherein the body defines an elongated beam extending between a first end and a second end, the elongated beam including a first flange and a second flange, each extending between the first end and the second end, and a web extending between and connecting the first flange and the second flange, and wherein at least one of the one or more laminates is disposed along the first flange and/or at least one of the one or more laminates is disposed along the second flange. In some devices, at least one of the one or more laminates is disposed along the first flange and at least one of the one or more laminates is disposed along the second flange.

In some devices, an outer surface of the first flange that faces away from the second flange is convex. In some devices, the body defines one or more ribs extending between the first flange and the second flange. In some devices, the width of the web decreases along the beam toward at least one of the first end and the second end.

In some devices, the beam includes an I-shaped cross-section. In some devices, at least one of the first flange and the second flange extends above and below the web. In some devices, at least one of the first flange and the second flange is angularly disposed relative to the web at an angle of approximately 90 degrees. In some devices, no portion of the beam extends beyond an outer surface of the first flange that faces away from the second flange. In some devices, no portion of the beam extends beyond an outer surface of the second flange that faces away from the first flange.

In some devices, the body defines one or more mounts configured to couple the device to the front of a vehicle. Some devices comprise one or more brackets configured to be coupled to the one or more mounts to couple the device to the front of a vehicle.

In some devices, at least one of the one or more laminates is disposed along the first flange. In some devices, the one or more laminates disposed along the first flange span a total distance along the first flange that is substantially equal to a distance, measured along the first flange, between the first and second ends. In some devices, the thickness of at least one of the one or more laminates that is disposed along the first flange decreases along the beam toward at least one of the first end and the second end. In some devices, the first flange is comprised substantially of, by weight and/or volume, at least one of the one or more laminates.

In some devices, at least one of the one or more laminates is disposed along the second flange. In some devices, the one or more laminates disposed along the second flange span a total distance along the second flange that is substantially equal to a distance, measured along the second flange, between the first and second ends. In some devices, the thickness of at least one of the one or more laminates that is disposed along the second flange decreases along the beam toward at least one of the first end and the second end. In some devices, the second flange is comprised substantially of, by weight and/or volume, at least one of the one or more laminates.

In some devices, the matrix material of at least one of the one or more laminates comprises a thermoplastic material, a thermoset material, or a combination thereof. In some devices, the matrix material of at least one of the one or more laminates comprises the plastic material. In some devices, the matrix material of at least one of the one or more laminates consists of the plastic material. In some devices, the plastic material comprises a thermoplastic material, a thermoset material, or a combination thereof.

In some devices, the fibers of at least one of the one or more laminates comprise carbon fibers, glass fibers, basalt fibers, aramid fibers, polyethylene fibers, polyester fibers, polyamide fibers, steel fibers, textile fibers, or a combination thereof. In some devices, the fibers of at least one of the one or more laminates comprise continuous fibers. In some devices, the fibers of at least one of the one or more laminates comprise discontinuous fibers.

In some devices, at least one of the one or more laminates includes a lamina comprising fibers, substantially all of which are substantially parallel with one another. In some devices, at least one of the one or more laminates comprises a first set of fibers, each of which is substantially aligned in a first direction, and a second set of fibers, each of which is substantially aligned in a second direction that is angularly disposed relative to the first direction. In some devices, the first set of fibers is comprised by a first lamina and the second set of fibers is comprised by a second lamina. In some devices, the second set of fibers is woven with the first set of fibers.

Some embodiments of the present methods comprise forming, in a mold, the composite body of any of the present devices. In some methods, the forming the one or more laminates in the mold comprises placing one or more layers of material, each comprising an arrangement of fibers, into the mold, and overmolding the plastic material onto the one or more layers of material. Some methods comprise placing the one or more laminates into the mold and overmolding the plastic material onto the one or more laminates.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A pedestrian protection device configured to be mounted to the front of a vehicle, the device comprising:
a composite body including:
a plastic material; and
one or more laminates, each comprising fibers dispersed within a matrix material;
wherein the body defines an elongated beam extending between a first end and a second end, the elongated beam including:
a first flange and a second flange, each extending between the first end and the second end; and
a web extending between and connecting the first flange and the second flange;
wherein at least one of the one or more laminates is disposed along the first flange and at least one of the one or more laminates is disposed along the second flange; and
wherein none of the one or more laminates are disposed along at least one portion of the web.

2. The device of claim 1, wherein an outer surface of the first flange that faces away from the second flange is convex.

3. A pedestrian protection device configured to be mounted to the front of a vehicle, the device comprising:
a composite body including:
a plastic material; and
one or more laminates, each comprising fibers dispersed within a matrix material;
wherein the body defines an elongated beam extending between a first end and a second end, the elongated beam including:
a first flange and a second flange, each extending between the first end and the second end; and
a web extending between and connecting the first flange and the second flange;
wherein an outer surface of the first flange that faces away from the second flange is convex;
wherein at least one of the one or more laminates is disposed along the second flange; and
wherein none of the one or more laminates are disposed along at least one portion of the web.

4. The device of claim 3, wherein at least one of the one or more laminates is disposed along the first flange.

5. The device of claim 3, wherein the matrix material of at least one of the one or more laminates comprises the plastic material.

6. The device of claim 5, wherein the matrix material of at least one of the one or more laminates consists of the plastic material.

7. A pedestrian protection device configured to be mounted to the front of a vehicle, the device comprising:
a composite body including:
a plastic material; and
one or more laminates, each comprising fibers dispersed within a matrix material;
wherein the matrix material of at least one of the one or more laminates comprises the plastic material;
wherein the body defines an elongated beam extending between a first end and a second end, the elongated beam including:
a first flange and a second flange, each extending between the first end and the second end; and
a web extending between and connecting the first flange and the second flange;
wherein at least one of the one or more laminates is disposed along the first flange and/or at least one of the one or more laminates is disposed along the second flange; and
wherein none of the one or more laminates are disposed along at least one portion of the web.

8. The device of claim 7, wherein the matrix material of at least one of the one or more laminates consists of the plastic material.

9. The device of claim 7, wherein at least one of the one or more laminates is disposed along the first flange and at least one of the one or more laminates is disposed along the second flange.

10. The device of claim 7, wherein:
an outer surface of the first flange that faces away from the second flange is convex; and
at least one of the one or more laminates is disposed along the second flange.

11. The device of claim 7, wherein the width of the web decreases along the beam toward at least one of the first end and the second end.

12. The device of claim 7, wherein the body defines one or more ribs extending between the first flange and the second flange.

13. The device of claim 7, wherein the first flange is comprised substantially of, by weight and/or volume, at least one of the one or more laminates, and/or the second flange is comprised substantially of, by weight and/or volume, at least one of the one or more laminates.

14. The device of claim 7, wherein the thickness of at least one of the one or more laminates that is disposed along the first flange decreases along the beam toward at least one of the first end and the second end.

15. The device of claim 7, wherein the thickness of at least one of the one or more laminates that is disposed along the second flange decreases along the beam toward at least one of the first end and the second end.

16. The device of claim 7, wherein the one or more laminates disposed along the first flange span a total distance along the first flange that is substantially equal to a distance, measured along the first flange, between the first and second ends.

17. The device of claim 7, wherein the one or more laminates disposed along the second flange span a total distance along the second flange that is substantially equal to a distance, measured along the second flange, between the first and second ends.

18. The device of claim 7, wherein the fibers of at least one of the one or more laminates comprise carbon fibers, glass fibers, basalt fibers, aramid fibers, polyethylene fibers, polyester fibers, polyamide fibers, steel fibers, textile fibers, or a combination thereof.

19. The device of claim 7, wherein at least one of the one or more laminates includes a lamina comprising fibers, substantially all of which are substantially parallel with one another.

20. The device of claim 7, wherein at least one of the one or more laminates comprises:
a first set of fibers, each of which is substantially aligned in a first direction; and
a second set of fibers, each of which is substantially aligned in a second direction that is angularly disposed relative to the first direction.
